(19) United States
(12) Patent Application Publication
(10) Pub. No.: US 2012/0320757 A1
(43) Pub. Date: Dec. 20, 2012

(54) Method and Node in an Internet Protocol Television (IPTV) Network

(75) Inventor: Thorsten Lohmar, Aachen (DE)

(73) Assignee: TELEFONAKTIEBOLAGET L M ERICSSON (PUBL), Stockholm (SE)

(21) Appl. No.: 13/519,601

(22) PCT Filed: Jan. 4, 2010
(86) PCT No.: PCT/EP10/50020

§ 371 Date: Sep. 5, 2012

(51) Int. Cl. H04L 29/04; H04L 12/26

(52) U.S. Cl. 370/241; 370/390

(57) ABSTRACT

A converter node 27 of an Internet Protocol Television (IPTV) Network 20 comprises a first port 32 for communicating with a receiver 23 (for example a set top box), and a second port 28 for communicating with a video headed end 25 (for example a source of IP Multicast traffic. The converter node also comprises a converting unit 31. In response to receiving, via the first port 32, a request from the receiver 23 to join an internet protocol multicast group (e.g. tune-in to an IPTV channel), the converting unit 31 of the converter node 27 is configured to convert IP Multicast traffic 29 received from the video headed end 25 via the second port 28 into IP Unicast traffic 33 (i.e. personalised traffic), which is forwarded to the receiver 23 via the first port 32.

### TECHNICAL FIELD

The invention relates to a method and node in an Internet Protocol Television (IPTV) network, and in particular to a method and node for providing improved services to subscribers in an IPTV network through the use of IP Unicast transmission in combination with IP Multicast transmission.

### BACKGROUND

Internet Protocol Television (IPTV) is a system through which a digital television service is delivered using the architecture and networking methods of the Internet Protocol (IP) over a packet-switched network infrastructure, such as the Internet.

Existing methods of providing IP Unicast transmission directly from the source to the end subscriber (i.e. point-to-point) are too expensive in terms of resources, which means that TV channels are therefore delivered to end users using IP Multicast transmission techniques (i.e. point-to-multipoint).

Users receive IP Multicast transmissions through equipment provided at the user's premises, such as a set top box. When a user wishes to view a certain TV channel, the user instructs the set top box to join a known IP Multicast group to receive the desired content. The mapping between a TV channel and an IP Multicast group is provided though an Electronic Service Guide (ESG), or other similar means.

FIG. 1 shows a basic overview of an IPTV network 1. At the subscriber side a television set, or set top box, 3a or 3b initiates channel change requests. A Residential Gateway (RGW) 5, also known as a Routing Gateway, aggregates traffic from multiple set top boxes 3a, 3b, while a Digital Subscriber Line Access Multiplexer (DSLAM) 7 aggregates traffic from multiple subscribers 9a, 9b. An edge router 11, also known as a Broadband Services Router (BSR), provides subscriber management and acts as a gateway into a backbone network 13.

IPTV services are offered to subscribers in such a network using IP Multicast transmissions. The control mechanism typically used to control delivery of multicast traffic to subscribers is the Internet Group Multicast Protocol (IGMP). IGMP commands are used to instruct the upstream equipment to stop sending (“leave”) one channel or to begin sending (“join”) another channel. However, using IP Multicast transmission in the home network has a number of disadvantages.

For example, content personalization to provide personalized TV channels (IP Multicast flows) constructed in the access system is impossible. This is because the operator has no control over whether one or more receivers (STBs) receive and render the content. In other words, when using an Intra-Frame Switcher in the access network, the IPTV channel is “multicasted” in the home network 9a to the set top boxes 3a and 3b. Thus, a second set-top-box 3b zapping to a channel which is already being watched by a first set top box 3a is “served” by the same RGW 5 with the same IP Multicast traffic. As a consequence, the RGW 5 will simply ignore the IGMP “join” message received from the second set top box 3b when trying to zap to a new channel. This is because the IP Multicast traffic is already being forwarded in the home network. Thus, the second set top box 3b will not receive an optimized Random Access Point (RAP) for joining the received data stream. This has a further disadvantage of not allowing the second set top box to zap quickly between channels.

Furthermore, if the IP Multicast traffic is provided using a Wireless Local Area Network (WLAN) within the home network, the IP Multicast traffic must be effectively “broadcasted” on the WLAN. Error correction techniques defined for such IP Multicast traffic being broadcast in the home network are less efficient that other known schemes, and do not offer error correction protocols such as Automatic Repeat Request (ARQ) protocols. Thus, the packet loss rate is higher. Further, IP Multicast does not provide as high a gain in the home network as it does in the operator's network. The home network must be dimensioned to carry for each receiver (e.g. each STB) the TV IP stream. It might be very seldom that two receivers (e.g. two STBs) receive the same TV channel, such that only a single IP Multicast flow is used to serve both receivers.

### SUMMARY

It is an aim of the present invention to provide a method and node for an Internet Protocol Television (IPTV) network, that alleviate or reduce one or more of the disadvantages mentioned above.

According to a first aspect of the present invention, there is provided a node in an internet protocol television network. The node comprises: a first port for receiving a request to join an internet protocol multicast group; a second port for receiving internet protocol multicast traffic including the requested internet protocol multicast group; and a converting unit for converting the requested internet protocol multicast group into internet protocol unicast traffic, and forwarding the internet protocol unicast traffic via the first port.

Providing IP unicast transmission on a final hop to an end user has the advantage of enabling the traffic to be customised to the end user, while also enabling better error correction techniques to be adopted.

According to one embodiment, a monitoring unit may also be provided in the node for monitoring the internet protocol multicast traffic received on the second port, the monitoring unit being adapted to detect one or more tags in the internet protocol multicast traffic, the one or more tags indicating that alternative data is to be forwarded via the first port.

The monitoring unit may be adapted to insert the alternative data into the internet protocol unicast traffic being forwarded via the first port.

According to one embodiment, the node comprises a memory for storing the alternative data. A selecting unit may also be provided for selecting which alternative data is to be forwarded with the internet protocol unicast traffic.

In one embodiment the node comprises a buffer for storing an internet protocol multicast group. One or more additional buffers may also be provided, each buffer storing an internet protocol multicast group that is to be forwarded via the first port. This has the advantage of enabling a fast channel change procedure to be performed more efficiently.

The node may form part of a routing gateway, an internet protocol replication point, or any other node between the video headed end and the end receiver in an IPTV network.

According to another aspect of the present invention, there is provided a method in a node of an internet protocol television network. The method comprises the steps of: receiving a request to join an internet protocol multicast group; receiving internet protocol multicast traffic including the requested internet protocol multicast group; and converting the requested internet protocol multicast group into internet protocol unicast traffic, and forwarding the internet protocol unicast traffic.

According to one embodiment, the method may further comprise the step of monitoring the received internet protocol multicast traffic to detect one or more tags in the internet protocol multicast traffic, the tags indicating that alternative data is to be forwarded.

The method may comprise the step of inserting the alternative data into the internet protocol unicast traffic being forwarded. In one embodiment the method further comprises the step of selecting which alternative data is to be forwarded with the internet protocol unicast traffic.

According to one embodiment the method further comprises the step of buffering an internet protocol multicast group. The buffering step may comprise the steps of buffering one or more internet protocol multicast groups that are to be forwarded.

The request to join an internet protocol multicast group may be received as a control protocol for real time protocol (RTCP) message, an internet group multicast protocol (IGMP) message, a real time streaming protocol (RTSP) message, or a transmission control protocol (TCP) message.

### BRIEF DESCRIPTION OF THE DRAWINGS

For a better understanding of the present invention, and to show more clearly how it may be carried into effect, reference will now be made, by way of example only, to the following drawings in which:

FIG. 1 shows a basic overview of a typical Internet Protocol Television (IPTV) network;

FIG. 2 shows a node of an IPTV network according to a first embodiment of the present invention;

FIG. 3 shows the method steps performed by the node of FIG. 2;

FIG. 4 shows a node of an IPTV network according to another embodiment of the present invention;

FIG. 5 shows the method steps performed by an embodiment of the present invention;

FIG. 6 shows a node of an IPTV network according to another embodiment of the present invention; and

FIG. 7 is a signalling diagram illustrating the steps performed by an embodiment of the present invention.

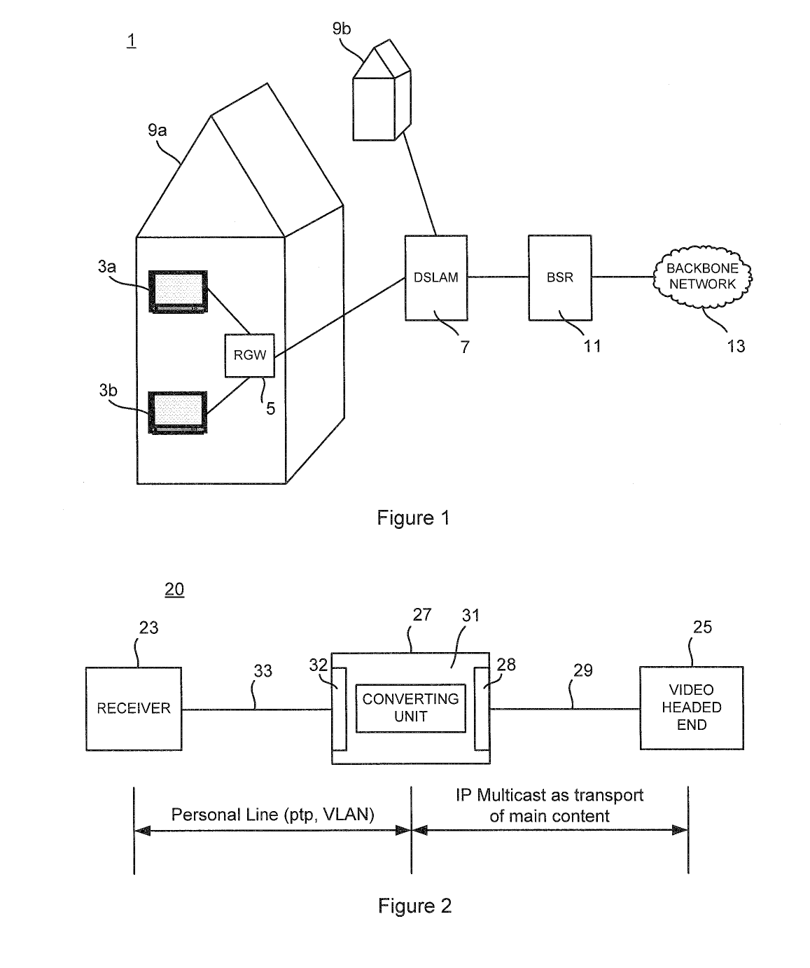

### DETAILED DESCRIPTION

FIG. 2 shows a basic overview of a node of an Internet Protocol Television (IPTV) Network 20 according to the present invention. In the IPTV network the receiver 23 represents user equipment provided at a subscriber location, for example a set top box. The video headed end 25 represents the source of IP Multicast traffic, for example a backbone network that delivers television channels. According to the invention there is provided a converter node 27 in the path between the receiver 23 and the video headed end 25. The converter node 27 comprises a first port 32 for communicating with the receiver 23, a second port 28 for communicating with the video headed end 25, and a converting unit 31. In response to receiving, via the first port 32, a request from the receiver 23 to join an IP Multicast group, the converting unit 31 of the converter node 27 is configured to convert IP Multicast traffic 29 received from the video headed end 25 via the second port 28 into IP Unicast traffic 33, which is forwarded to the receiver 23 via the first port 32.

It will be appreciated that the IP Multicast traffic received from the video headed end 25 may pass through one or more nodes on its route to the converter node 27, including, but not limited to, a Broadband Services Router (BSR). It will also be appreciated that the IP Unicast traffic may also pass through one or more nodes on its route to the receiver 23, including, but not limited to, a Residential Gateway (RGW) or Digital Subscriber Line Access Multiplexer (DSLAM).

The converter node 27 may be provided as a stand-alone device, or integrated with other devices presently found in the path between the source of IP Multicast traffic and the end destination.

For example, the converter node 27 may form part of an IP Multicast Replication node, which is adapted to replicate the IP Multicast traffic to multiple end users. IP Unicast transmissions 33 from the converter node 27 down to the end-user, i.e. the receiver 23, may be provided over a personal line, such as a point-to-point link, or a Virtual Local Area Network (VLAN).

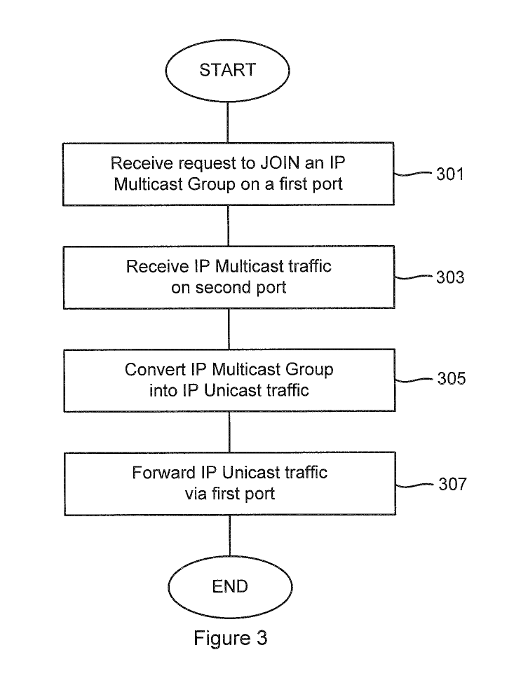

FIG. 3 is a flow chart describing the steps performed by a node according to one embodiment of the invention. In step 301 the node receives on a first port a request to join an IP Multicast group, i.e. tune-in to a traffic channel or IPTV channel. The node receives IP Multicast traffic, including the requested IP Multicast group (i.e. traffic channel or IPTV channel), on a second port, step 303. It will be appreciated that the IP multicast traffic received on the second port may be received concurrently, or before, the request received on the first port to join an IP Multicast group. In step 305 the requested IP Multicast group is converted into IP Unicast traffic (personalized traffic) for forwarding via the first port, i.e. to the node making the request to join the IP Multicast group.

The provision of IP Unicast transmission on the final hop between the converter node 27 and the receiver 23 enables a number of enhanced services to be offered to the end user, including a Fast Channel Change (FCC) procedure, personal advertisements and increased transmission robustness, as will be described in further detail below.

Furthermore, by having the IP Unicast transmission present only during the final hop to the subscriber, the invention does not have the disadvantages associated with providing IP Unicast transmission directly from the source to the end subscriber, i.e. through the entire transmission. There is therefore provided an IPTV network in which traffic in an upstream portion of the network is provided in an IP Multicast format, and traffic in a downstream portion of the network provided in an IP Unicast format.

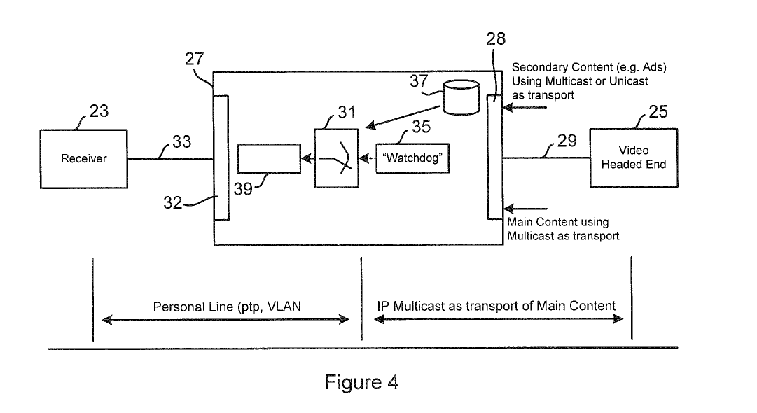

FIG. 4 shows a more detailed view of a converter node 27 according to one embodiment of the present invention. As with FIG. 2, a receiver 23 represents user equipment provided at a subscriber location, for example a set top box. The video headed end 25 represents the source of IP Multicast traffic, for example a backbone network that delivers television channels. A converter node 27 is provided in the path between the receiver 23 and the video headed end 25. The converter node 27 comprises a first port 32 for communicating with the receiver 23, a second port 28 for communicating with the video headed end 25, and a converting unit 31. In response to receiving, via the first port 32, a request from the receiver 23 to join an internet protocol multicast group, the converting unit 31 of the converter node 27 is configured to convert IP Multicast traffic 29 received from the video headed end 25 via the second port 28 into IP Unicast traffic 33, which is forwarded to the receiver 23 via the first port 32.

The receiver 23, i.e. end user, can request a stream of traffic by sending fast channel change requests to the converter. The request may be sent, for example, using an RTCP (Control protocol for Real Time Protocol, RTP) message, i.e. at a User Datagram Protocol (UDP) level, or an Internet Group Multicast Protocol (IGMP) message, i.e. at an Internet Protocol (IP) level, or with a Real Time Streaming Protocol (RTSP) message, i.e. at a Transmission Control Protocol (TCP) level. An RTSP command can be used instead of an IGMP command to fetch the data, the RTSP command typically being used only to “join” and “leave” certain IPTV channels. It is noted that the invention is intended to encompass such requests being sent using other messages or protocols.

As will be appreciated by a person skilled in the art, IGMP is always processed by the next router. Of course, “IGMP forwarding” is defined, which allows a router (for example an RGW) to forward the IGMP to the next router (for example a DSLAM). However, the original source of the IGMP message (here the STB) gets lost. The DSLAM regards the home router as the source. RCTP/UDP or TCP (IP Unicast) overcomes this problem. RTCP/UDP or TCP is sent on IP Unicast to the converting node 27.

The invention therefore enables channel change requests to be made for IP Multicast traffic, but the traffic delivered to the receiver as IP Unicast traffic. As such, the converter node 27 can be used with conventional receivers 23, such as conventional set top boxes.

According to the embodiment of FIG. 4, the converter node 27 comprises a monitoring unit 35 for monitoring IP Multicast traffic 29 received via the second port 28 from the video headed end 25, i.e. acting as a form of “watchdog”. The converter 27 also comprises a memory unit 37 for storing or queuing additional data, such as advertising material, for onward transmission with the IP Unicast traffic 33 via the first port 32 to the receiver 23.

The monitoring unit 35 is configured to identify tags or fields in the received IP Multicast traffic 29, which enable the converting unit 31 to insert the additional data (such as advertising material) into the IP Unicast stream that is forwarded to the receiver 23. The additional data stored in the memory unit 37 may be received in the form of “Secondary Content” in the IP Multicast traffic received from the video headed end 25. Alternatively, the additional material stored in the memory unit 37 may be received from some other source, such as IP Unicast traffic from the video headed end 25, from other links not shown, or uploaded directly into the memory unit 37.

Since the communication link 33 between the converter node 27 and the receiver 23 carries IP Unicast traffic, for example on a point-to-point link or VLAN, the communication link 33 between the converter node 27 and the receiver 23 is a “personal” link, thereby enabling the additional data to be personalised for a particular receiver 23. For example, the converter node 27 may be configured to insert personalised advertisements stored in the memory unit 37, which are forwarded to the receiver 23 with the IP Unicast traffic on the communication link 33.

As another example, the converter node 27 may be configured to always play an advertisement at a particular point in the IP Unicast traffic being forwarded to the receiver 23. For example, the converter may be configured to always play an advertisement, such as a personal advertisement, when a user first tunes to a new channel, or to play a specific advertisement at the beginning of a specific channel (for example a news channel). As an alternative to storing the advertisement locally in the memory unit 37 of the converter, it is noted that the additional data for insertion with the IP Unicast traffic may be received from a remote source when needed, i.e. in a dynamic manner from another location.

As mentioned above, the receiver 23 may send a channel change command to the converter node 27 (for example using RTCP, RTSP or IGMP). The converter node 27 comprises an interface unit 39, which is configured to provide additional functions that may be required to process the channel change command and to start forwarding traffic to the receiver 23. The channel change command contains an identifier of the new TV channel, which may be the IP Multicast address of the new TV channel or a more general identification string (RTSP URI or a channel-id string in a RTCP payload). The receiver has a mapping between “human understandable TV channel names” and the technical representation (e.g. IP Multicast address) of the IPTV system.

It will be appreciated from the above that the invention allows “normal” IP Unicast (point to point on Layer 3) to be used within the home network, even for the IPTV traffic.

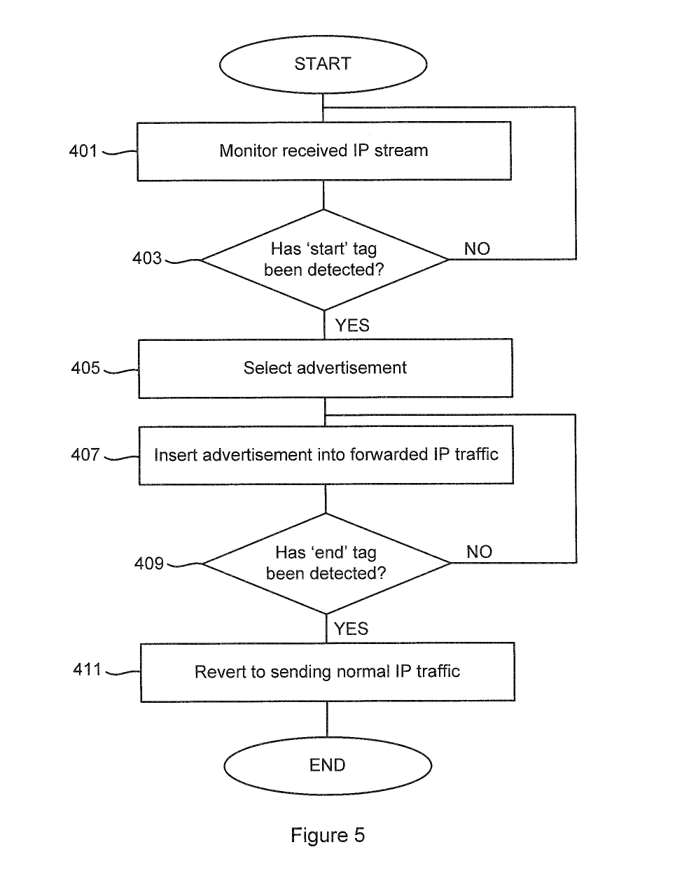

The monitoring unit 35 of FIG. 4 acts as watchdog for detecting triggers (or tags) that may be embedded into the regular program stream. FIG. 5 describes in greater detail the steps that may be performed by one embodiment, in which “start” and “end” tags are embedded into the regular program stream. It is noted that a “tag” might include, amongst other things, a protocol header flag or information in an extension header.

In steps 401 and 403 the monitoring unit monitors the received IP stream to determine if a “start” tag is present. If in step 403 a “start” tag is detected in the received IP stream, the monitoring unit triggers the selection of an advertisement, step 405, and the insertion of the advertisement into the IP stream being forwarded to the receiver, step 407. The selecting of an advertisement may be performed by a selecting unit (not shown), which select an appropriate advertisement based on a selection criterion. When an “end” tag is detected in step 409, the monitoring unit triggers the switch-back from the forwarding of an advertisement to the forwarding of the regular program, step 411.

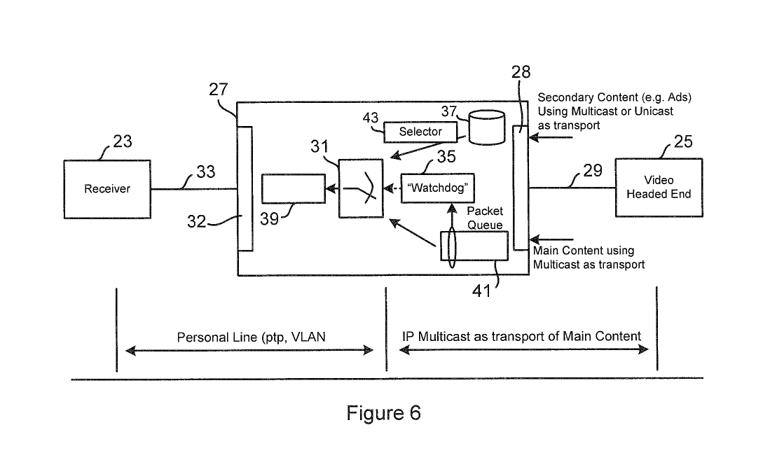

FIG. 6 shows a converter node 27 according to another embodiment of the present invention, comprising many features in common with FIG. 4 described above. In this particular embodiment, the converter node 27 comprises a buffer 41 (i.e. a packet queue) for queuing IP packets received from the video headed end 25. The buffer 41 is of particular importance in the case of a “Fast Channel Change” (starting with a video Key-Frame). It is noted, however, that the buffer 41 may be small, or even not present, when the fast channel change is realized in a different way. The buffer 41 contains the received IP Multicast packets and optionally the reception timestamps. In some cases, the converting unit 27 strips off the IP Multicast headers and adds an IP Unicast IP header. The destination address is then the IP address of the receiver 23. Alternatively, (in case of RTCP or RTSP), the converter unit 27 strips off the IP header and the UDP header and adds new IP headers/UDP headers. The header information is selected to reach the receiver 23. In case of Network Address Translation (NAT) in the RGW, the IP destination address might be that of the RGW, with an UDP port uniquely identifying the transport pipe to the receiver. The buffer 41 may store the packets as they arrive, with preferably one queue per IP Multicast group, i.e. a separate queue for each TV channel to be viewed. Each queue of the buffer 41 can be shared among potentially many end users. It is noted that the unicast packet headers depend on the actual receiver. It is also noted that the buffer 41 is preferably configured to store the main content of the received IP packets (i.e. as opposed to the full traffic stream which could include other information, such as secondary content such as advertising material).

The buffer 41 enables an IPTV Fast Channel Change (FCC) procedure to be improved. The buffer 41 buffers the incoming IP Multicast packets for a predetermined period of time, for example 1 second or more (or more than 1 Group of Pictures (GOP) period). Upon receipt of a Channel Change request (e.g. IGMP join to an IP Multicast group), the converter node 27 starts forwarding traffic from an IP packet, which contains a PAT (PID==0) table. The invention enables a fast channel change procedure to be improved since the buffer 41 will have a separate queue for each Multicast IP group, i.e. TV channel to be viewed, thereby enabling set top boxes to locate a Random Access Point for each respective TV channel. The converter node 27 may also be adapted to identify Program Specific Information (PSI) tables and to cache them, thereby allowing a fast channel change.

According to one embodiment, to simplify the processing in the converter node 27, all IP Packets containing PSI tables may be marked in the IP headers or RTP headers, for example by the IPTV Head end system. This is an optional improvement to simplify the processing.

FIG. 6 also shows the selecting unit 43 that may be provided to select a particular advertisement for insertion in the IP data stream being forwarded to the receiver 23, as mentioned above in the flow diagram of FIG. 5.

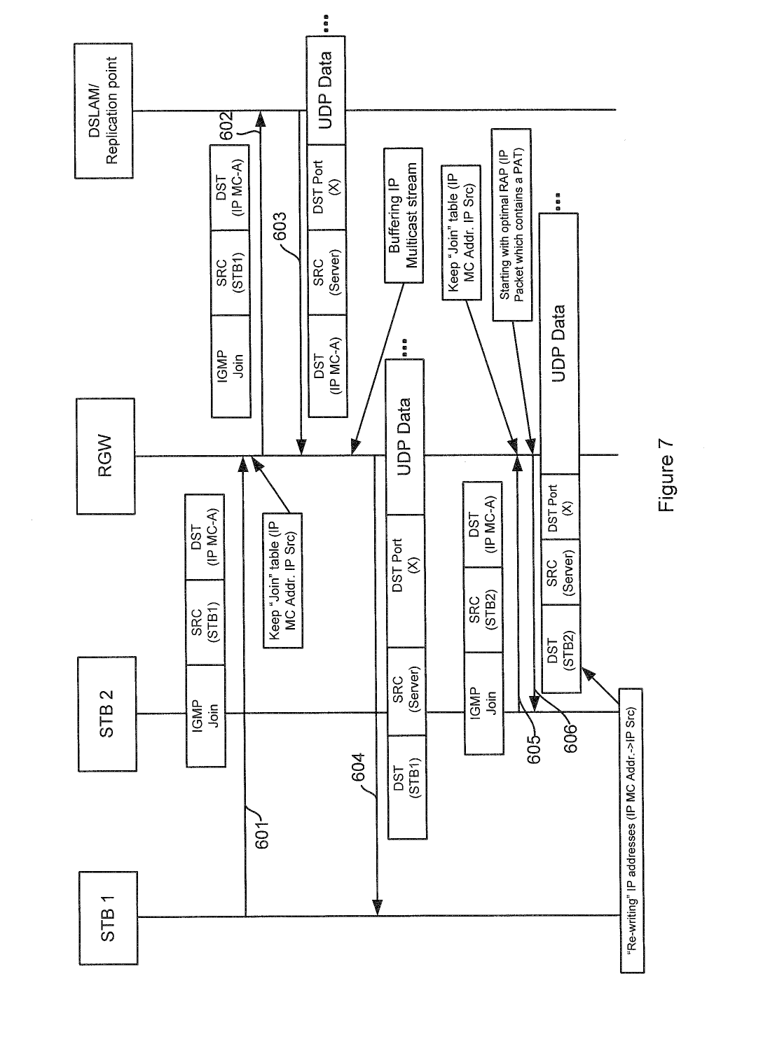

FIG. 7 shows a detailed message sequence diagram, illustrating how a channel change request from a second set top box STB2 within a home network can be improved using the invention described above. For the purpose of this example it is assumed that the converter node 27 of FIGS. 2, 4 and 6 forms part of the Routing gateway (RGW) of FIG. 7. It will be appreciated, however, that the converted node 27 providing these functions may alternatively be provided elsewhere, for example in an IP Multicast Replication Node.

In step 601 the set top box STB1 requests an IPTV channel. This may comprise sending an IPGM “join” message, which is transported on IP Multicast address “IP MC-A”. The RGW implements the normal IGMP forwarding functionality to ensure that the IGMP “join” message is forwarded, step 602, to an upstream node such as a DSLAM or IP Replication point. The RGW stores information, such as the IP Source address of the set top box making the IPGM join request, for later use. In other words, since the RGW implements the converter node 27 in this case, the RGW maintains a database (for example containing only a few entries) of the active receivers in the home network. The database table may contain the receiver list per incoming multicast flow (i.e. per queue of the buffer 41).

When the UDP traffic is received in step 603 for the requested IP Multicast group, the RGW replaces the IP Multicast address (i.e. IP MC-A) with an IP Unicast address of the requesting set top box STB1 (shown in the example as IP destination address “STB1”), which is forwarded to the set top box STB1 in step 604. In the case of an IGMP join, the IP Multicast header will be replaced by an IP Unicast header. In the case of RTCP or RTSP switching, the IP Multicast/UDP/RTP headers are replaced by IP Unicast/UDP/RTP headers. The RGW uses the information previously stored upon receipt of the IPGM join request to determine if a received IP Multicast address should be replaced with an IP Unicast address. In the embodiment above the IP Multicast traffic is always changed into IP Unicast traffic. However, if desired, a set top box may selectively decide whether it wants to receive IP Multicast or IP Unicast traffic.

The IP Multicast stream received in step 603 is buffered at the RGW. As mentioned above, according to one embodiment (whereby a fast channel change is desired) the buffer may comprise a separate queue for each IP Multicast Group, i.e. TV channel to be viewed.

Next, it is assumed that a second set top box STB2 wishes to receive the same IP traffic stream, for example joining the same data stream (IP Multicast group) to receive the same TV channel.

When the RGW receives an IGMP join message in step 605 for an IP Multicast group from the second set top box STB2, the RGW checks its context, and determines whether or not this IP Multicast flow is already in progress. When the RGW determines that it does not already serve the IP Multicast group, it forwards the request to the DSLAM/Replication Point (the steps not being specifically shown in FIG. 7, but correspond to the steps described above in steps 602, 603). However, if the RGW determines that it already serves the IP Multicast group, the RGW starts forwarding the UDP flow as an IP Unicast flow to the IP destination address indicated in the IGMP join message.

As mentioned above, the RGW may comprise a buffer for buffering each actively forwarded IP Multicast group, i.e. TV channel to be viewed. This is particularly advantageous if the access network implements an “Intraframe” Switcher to support Fast Channel Change (FCC). In such a case, if the RGW maintains a short buffer for each actively forwarded IP Multicast group, a second (or third) IGMP join request to an already active IP Multicast group is served with a Program Association Table (PAT) packet first (PID==0). The RGW (which in this example implements the converter node 27) looks for the PSI information and for the Key Frame. An optimized random access point to support fast channel change into the stream is then made in the following sequence: first PSI tables, then Key-Frame.

To realise the invention it will be appreciated that a set top box must also accept IP Unicast on a given port.

The “forwarding” described above is preferably added to the “IGMP forwarding” functions of RGWs. It is noted that, in the case where the RGW does not perform the “normal” IP Multicast Routing, then the RGW would not send IGMP messages to the access network, but other messages, for example PIM-SM instead.

The invention described above has the advantage of making IPTV transmissions in the home environment more reliable, since WLAN ARQ mechanisms may be used with Unicast traffic.

The invention also has the advantage that access network based “Intra frame switching” for more than one set top box in the home network becomes possible, since each different set top box in the home network is served with unique streams. No additional DSL capacity is required to provide fast IPTV channel Switching.

Using IP Unicast (Layer 3 unicast) instead of VLANs (Layer 2) has the advantage that it does not place any requirement on other home network nodes (i.e. VLAN support in receiving devices and other home switches).

Although the embodiments above have been described in the context of routing Internet Protocol Television traffic, it is noted that the invention is equally applicable to other forms of Internet Protocol traffic that may be converted from multicast format into unicast format.

It is noted that the converter according to the present invention may be realised as a stand-alone node, or integrated with another node that already exists within the network.

For example, according to one embodiment the converter may form part of a RGW as described in FIG. 7.

According to another embodiment the converter may form an integral part of a Multicast Replication point (MC-RP) in the network. In such an embodiment, the MC-RP may still process IGMP “join” and “leave” messages received from a receiver in the conventional manner. However, the MC-RP does not forward the traffic using the IP Multicast as IP Multicast. Instead, the MC-RP reads the source address of the “IGMP Join request” or the content of a new channel change request packet, and forwards all IP packets to the source of the IGMP message using IP Unicast. The MC-RP is adapted to rewrite the IP packet headers, but keep UDP ports untouched.

It will be appreciated that the invention effectively forms a logical point-to-point connection between the converter and the end user. The term “unicast” therefore provides personalized internet protocol traffic between the converter and the end user. Other realizations to IP unicast might be to use VLAN technology and send the IP Multicast stream, whereby VLAN technology can be used to create a personalized point-to-point connection below IP Multicast.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-15. (canceled)

16. A node in an internet protocol television network, the node comprising:
a first port for receiving internet protocol multicast traffic comprising one or more internet protocol multicast groups;
a converting unit configured to convert the one or more internet protocol multicast groups into one or more internet protocol unicast traffic signals;
a buffer comprising one or more queues that are each configured to store a respective one of the one or more internet protocol unicast traffic signals; and
a second port for receiving a request to join an internet protocol multicast group;
wherein the converter unit is further configured to forward from a respective queue the internet protocol unicast traffic signal corresponding to the requested internet protocol multicast group, via the second port.

17. The node of claim 16, further comprising a monitoring unit configured to monitor the internet protocol multicast traffic received on the first port, and to detect one or more tags in the internet protocol multicast traffic, the one or more tags indicating that alternative data is to be forwarded via the second port.

18. The node of claim 17, wherein the monitoring unit is configured to insert the alternative data into the internet protocol unicast traffic being forwarded via the second port.

19. The node of claim 17, further comprising a memory for storing the alternative data.

20. The node of claim 17, further comprising a selecting unit configured to select which alternative data is to be forwarded with the internet protocol unicast traffic.

21. The node of claim 16, wherein the one or more queues each store an internet protocol multicast group that is to be forwarded via the second port.

22. The node of claim 16, wherein the converter is further configured, in response to receiving a second request via the second port to join the same internet protocol multicast group, to forward from the respective queue the internet protocol unicast traffic signal corresponding to the requested internet protocol multicast group, via the second port.

23. The node of claim 16, wherein the node forms part of a routing gateway, or an internet protocol replication point.

24. A method in a node of an internet protocol television network, the method comprising:
receiving internet protocol multicast traffic comprising one or more internet protocol multicast groups;
converting the one or more internet protocol multicast groups into one or more internet protocol unicast traffic signals;
buffering one or more internet protocol unicast traffic signals in one or more queues;
receiving a request to join an internet protocol multicast group; and
forwarding from a respective queue the internet protocol unicast traffic signal corresponding to the requested internet protocol multicast group.

25. The method of claim 24, further comprising monitoring the received internet protocol multicast traffic signal to detect one or more tags in the internet protocol multicast traffic, the tags indicating that alternative data is to be forwarded.

26. The method of claim 25, further comprising inserting the alternative data into the internet protocol unicast traffic signal being forwarded.

27. The method of claim 25, further comprising selecting which alternative data is to be forwarded with the internet protocol unicast traffic signal.

28. The method of claim 24, wherein said buffering comprises buffering one or more internet protocol multicast groups that are to be forwarded.

29. The method of claim 24, further comprising receiving a second request to join the same internet protocol multicast group, and forwarding from the respective queue the internet protocol unicast traffic signal corresponding to the requested internet protocol multicast group.

30. The method of claim 24, wherein the request to join an internet protocol multicast group is received as a control protocol for real time protocol, RTCP, message, an internet group multicast protocol, IGMP, message, a real time streaming protocol, RTSP, message, or a transmission control protocol, TCP, message.
